(19) United States
(12) Patent Application Publication
(10) Pub. No.: US 2018/0216582 A1
(43) Pub. Date: Aug. 2, 2018

(54) INTERNAL COMBUSTION ENGINE FOR A MOTOR VEHICLE

(71) Applicant: Mahle International GmbH, Stuttgart (DE)

(72) Inventors: Sascha Naujoks, Pfinztal (DE); Simon Streng, Stuttgart (DE); Peter Wieske, Korntal-Muenchingen (DE)

(21) Appl. No.: 15/881,772

(22) Filed: Jan. 27, 2018

(30) Foreign Application Priority Data
Feb. 1, 2017 (DE) 102017201599.3

(51) Int. Cl. F02M 26/36; F02M 26/28; F02M 26/32; F01P 9/06; F01P 3/20

(52) U.S. Cl. CPC F02M 26/36; F02M 26/28; F01P 3/20; F01P 9/06; F02M 26/32

(57) ABSTRACT

An internal combustion engine for a motor vehicle may include at least one cylinder including a combustion chamber for combustion of an air-fuel mixture introduced into the combustion chamber. The engine may also include a fresh air feed for supplying fresh air into the combustion chamber, and an exhaust gas removal system for removing exhaust gas from the combustion chamber. The engine may further include an exhaust gas recirculation system fluidically communicating with the fresh air feed and the exhaust gas removal system for at least partial recirculation of the removed exhaust gas. Additionally, the engine may include a fuel supply device arranged in the exhaust gas recirculation system for introducing a fuel into the exhaust gas guided through the exhaust gas recirculation system, and a fuel vaporizer arranged in the exhaust gas recirculation system configured to chemically convert hydrocarbons contained in the fuel introduced into the exhaust gas.

### CROSS-REFERENCE TO RELATED APPLICATIONS

This application claims priority to German Patent Application No. DE 10 2017 201 599.3, filed on Feb. 1, 2017, the contents of which are hereby incorporated by reference in its entirety.

### TECHNICAL FIELD

The present invention relates to an internal combustion engine for a motor vehicle as well as a motor vehicle with such an internal combustion engine.

### BACKGROUND

Conventional internal combustion engines are usually fitted with an exhaust gas recirculation system in order to reduce the emission of nitric oxides which are produced during the combustion of fuel in petrol engines and also diesel engines.

During the combustion of the fuel air mixture introduced into the combustion chambers of the internal combustion engine, hydrocarbon molecules of the fuel used are oxidized with oxygen. The oxygen introduced into the combustion chamber is thereby almost or even completely consumed so that almost no more oxygen molecules are present in the exhaust gas. If exhaust gas is now mixed with the fresh air introduced into the combustion chamber, the oxygen concentration of the mixture of fresh air and exhaust gas decreases. In order to nevertheless completely burn the fuel injected into the combustion chamber, in modern internal combustion engines less fuel is injected as a result of the lower oxygen concentration so that the fuel consumption of the internal combustion engine overall decreases.

Regardless of the previously explained advantage of a reduced fuel consumption which can be achieved by means of exhaust gas recirculation system, it is also advantageous to use a fuel having the highest possible knock resistance in the internal combustion engine, in particular if the internal combustion engine is a petrol engine. In this way, it can be prevented that as a result of the simultaneous explosion of a large part of the fuel-air mixture in the relevant combustion chamber—this effect is known to the person skilled in the art under the term “knocking”—the friction bearings and other wear-sensitive components of the internal combustion engine are exposed to an undesirably high loading.

### SUMMARY

It is therefore an object of the present invention to provide an improved embodiment for an internal combustion engine which is characterized by a low fuel consumption and good wear properties.

This problem is solved according to the invention by the subject matters of the independent claim(s). Advantageous embodiments are the subject matter of the dependent claims.

The basic idea of the invention is accordingly to provide an internal combustion engine with an exhaust gas recirculation system in which liquid fuel is additionally injected into the exhaust gas to be recirculated and is thoroughly mixed with the exhaust gas to be recirculated. Essential to the invention is a catalytic fuel vaporizer arranged in the exhaust gas recirculation system by means of which, by vaporization of the fuel, the long-chain hydrocarbons contained in the fuel are converted into hydrocarbons with a smaller chain length.

Such a conversion of long-chain hydrocarbons into shorter-chain hydrocarbons is associated with an increase in the knocking resistance of the fuel mixed with the exhaust gas. The knocking resistance is expressed by the octane number or knock number in the case of petrol for petrol engines. The octane number or knock number of the converted fuel is therefore increased according to the invention. In this way, as a result of the fuel having increased knock resistance contained in the exhaust gas to be recirculated, which is introduced into the combustion chambers together with the exhaust gas to be recirculated, the wear resistance of the internal combustion engine is improved. In addition, the fuel consumption of the internal combustion engine is reduced to a not inconsiderable extent with the aid of the recirculated gas.

The internal combustion engine comprises at least one cylinder which has a combustion chamber for combustion of an air-fuel mixture. Furthermore, a fresh air feed is provided for supplying fresh air into the combustion chamber of the at least one cylinder. Furthermore an exhaust gas removal system is provided for removing exhaust gas produced in the combustion chamber of the at least one cylinder from the combustion chamber or the cylinder. In addition, the internal combustion engine comprises an exhaust gas recirculation system which communicates fluidically with the fresh air feed and the exhaust gas removal system for recirculation of the exhaust gas removed from the cylinder into the cylinder. Furthermore, a fuel supply device is arranged in the exhaust gas recirculation system for introducing fuel into the exhaust gas guided through the exhaust gas recirculation system. A fuel vaporizer arranged in the exhaust gas recirculation system is configured according to the invention for chemical conversion of hydrocarbons contained in the fuel introduced into the exhaust gas.

According to a preferred embodiment, an exhaust gas cooler for cooling the mixture of exhaust gas and fuel emerging from the fuel vaporizer is arranged downstream of the fuel vaporizer. The term “downstream” in the present case and also hereinafter relates to a principal direction of flow of the exhaust gas through the exhaust gas recirculation system. By means of the said measure, an undesirable loss of heat of the fuel in the exhaust gas can be kept low or ideally can even be avoided.

In an advantageous further development, the fuel vaporizer is configured for converting long-chain hydrocarbons contained in the exhaust gas into shorter-chain hydrocarbons as a catalytic fuel vaporizer. This means that the fuel vaporizer acts as a catalyst during oxidation of the hydrocarbons contained in the fuel. In this case, the fuel contained in the exhaust gas is vaporized. The temperature level in the fuel required for the oxidation reaction is fundamentally provided by the exhaust gas to be recirculated. By means of the previously described further development, the knock resistance of the fuel converted in the fuel vaporizer can be increased in a simple manner.

Expediently, the fuel vaporizer can be configured for converting the hydrocarbon compound C₈H₁₈ into the hydrocarbon compound C₃H₈. In variants—by suitable configuration of the catalytic fuel vaporizer—other hydrocarbon compounds can also be converted.

Particularly expediently the fuel vaporizer is configured in such a manner that the knock number of the fuel is increased by at least 2 ROZ after conversion of the hydrocarbon chains.

In another advantageous embodiment the fuel vaporizer comprises a vaporizer housing which delimits a housing interior through which the exhaust gas and the fuel can flow. In this further development, a catalytic coating can be applied to a housing inner wall of the vaporizer housing. In this way, the catalysts required to carry out the chemical oxidation reactions can be provided with a high cross-section.

According to another preferred embodiment, the fuel vaporizer comprises an electrical heating device for heating the mixture of the exhaust gas and the fuel to be converted in the fuel vaporizer. In this way, the temperature required for initiation of the oxidation reactions can also be achieved if the exhaust gas should not have the temperature required for this.

Particularly preferably the fuel supply device can comprise at least one fuel injector for injecting fuel into the exhaust gas recirculation system. By means of such a fuel injector a particularly homogeneous mixing of the exhaust gas with the injected fuel to be converted in the fuel vaporizer can be achieved. As a result, a particularly homogeneous conversion of the hydrocarbons contained in the fuel is achieved in the fuel vaporizer.

In a further advantageous further development of the invention, the exhaust gas cooler is configured as a heat exchanger through which the mixture of exhaust gas and fuel to be cooled and, fluidically separated from this mixture, a coolant can flow. For cooling the mixture of exhaust gas and fuel, the coolant flowing through the heat exchanger is also thermally coupled in this to the mixture of exhaust gas and unconverted fuel guided through the heat exchanger. Such heat exchangers are commercially available in various different forms and therefore can be integrated particularly simply and therefore cost-effectively in the exhaust gas recirculation system.

Preferably the internal combustion engine provided with the exhaust gas recirculation system and the fuel vaporizer is configured as a petrol engine.

The invention further relates to a motor vehicle having a previously described internal combustion engine. The previously described advantages of the internal combustion engine are therefore also transferred to the motor vehicle according to the invention.

According to a preferred embodiment, the motor vehicle is provided with a refrigeration system. Said refrigeration system comprises a refrigeration circuit through which a coolant flows in which the exhaust gas cooler configured as a heat exchanger is incorporated.

In an advantageous further development said heat exchanger comprises first fluid paths which communicate fluidically with the refrigeration circuit for coolant to flow through. The heat exchanger additionally comprises second fluid paths which communicate fluidically with the exhaust gas recirculation system for the mixture of exhaust gas and fuel to be cooled to flow through. In this further development, the first fluid paths are connected thermally to the second fluid paths for cooling the mixture of exhaust gas and fuel in the heat exchanger. By means of such a heat exchanger, which can be configured for example as a ribbed tube heat exchanger or as a stacked plate heat exchanger, an effective thermal coupling of the refrigerant with the exhaust gas to be cooled is possible.

Expediently, the refrigeration system can be part of an air-conditioning system provided in the motor vehicle for air conditioning the vehicle interior of the motor vehicle. In this way an air-conditioning system installed in any case in the motor vehicle as standard can be used as a refrigeration system for cooling the mixture of exhaust gas to be recirculated and fuel. The provision of a separate refrigeration system for this purpose is therefore dispensed with which is associated with considerable cost advantages.

Further important features and advantages of the invention are obtained from the subclaims, from the drawings and from the relevant description of the figures with reference to the drawings.

It is understood that the features mentioned previously and to be explained further hereinafter can be used not only in the respectively given combination but also in other combinations or alone without departing from the scope of the present invention.

Preferred exemplary embodiments of the invention are presented in the drawings and are explained in detail in the following description.

### BRIEF DESCRIPTION OF THE DRAWINGS

In the figures:

FIG. 1 shows an example of an internal combustion engine according to the invention,

FIG. 2 shows the fuel vaporizer essential to the invention, arranged in the exhaust gas recirculation system of the internal combustion engine.

### DETAILED DESCRIPTION

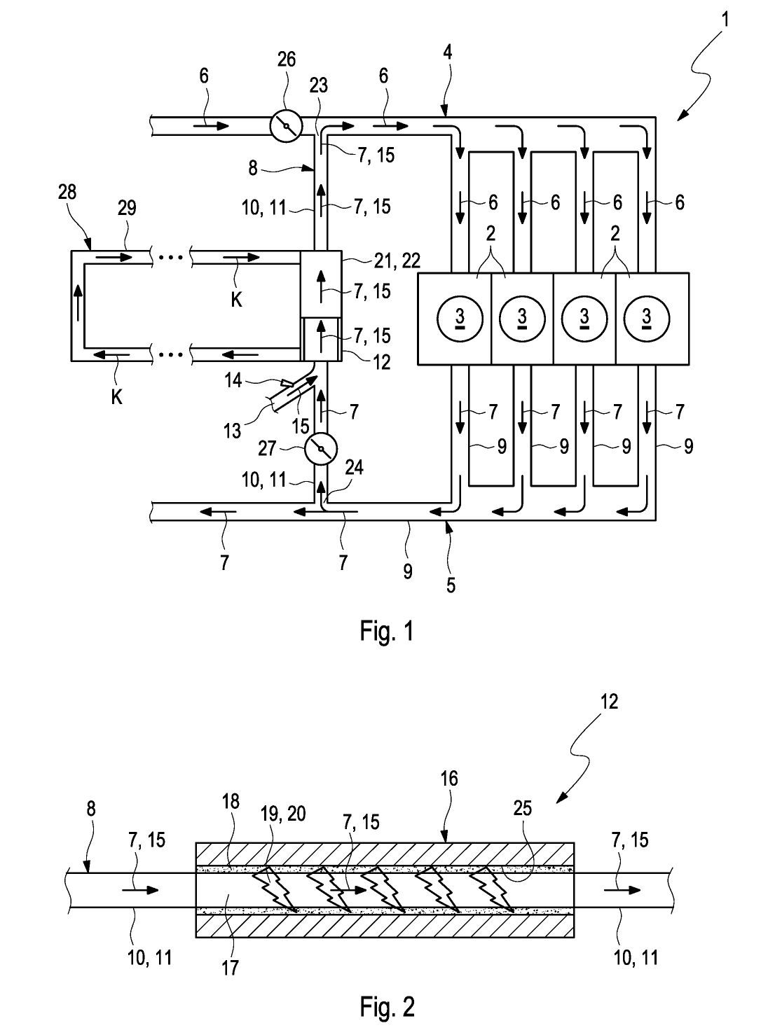

FIG. 1 illustrates in schematic view an example of an internal combustion engine 1 according to the invention which can be designed as a petrol engine. In the example in FIG. 1 the internal combustion engine 1 is implemented as a four-cylinder engine and accordingly has four cylinders 2. In each cylinder 2 a combustion chamber 3 is provided for combustion of the fuel-air mixture introduced into the combustion chamber 3. It is understood that in variants of the example, a different number of cylinders 2 and therefore also a different number of combustion chambers 3 can be provided in the internal combustion engine 1.

Furthermore the internal combustion engine 1 comprises a fresh air supply 4 for supplying fresh air 6 into the combustion chambers 3 of the cylinder 2. This can be part of a fresh air system of the internal combustion engine 1 not shown in detail in the figures. The supply of fresh air 6 into the combustion chambers 3 can be controlled with the aid of a valve device 26 arranged in the fresh air supply 4. The internal combustion engine 1 further comprises an exhaust gas removal system 5 for removing exhaust gas 7 produced in the combustion chambers 3 of the cylinder 2 by combustion of the fuel-air mixture. The exhaust gas removal system 5 can be part of an exhaust gas system not shown in detail in the figures which removes the exhaust gas 7 from the combustion chambers 3 via individual exhaust gas pipes 9 which are usually designated as manifolds.

The internal combustion engine 1 further comprises an exhaust gas recirculation system 8 for partial recirculation of the exhaust gas 7 removed from the combustion chambers 3 into the cylinders 2 of the internal combustion engine 1. For this a branch 24 is provided in the exhaust gas removal system 5 in which the exhaust gas recirculation system 8 branches off from the exhaust gas removal system 5. A part of the exhaust gas 7 removed from the cylinders 2 of the internal combustion engine 1 leaves the exhaust gas removal system 5 in the branch 24 and is then guided through the exhaust gas recirculation system 8. The exhaust gas recirculation system 8 has a recirculation line 10 through which the exhaust gas 7 to be recirculated flows. The recirculation line 10 can be formed at least in sections in the manner of a recirculation pipe 11. The exhaust gas recirculation system communicates fluidically with the exhaust gas removal system 5 and with the fresh air supply 4. The recirculation of the exhaust gas 7 into the combustion chambers 3 can be controlled with the aid of a valve device 27 arranged in the exhaust gas recirculation system 8.

As can be seen in the diagram in FIG. 1, a fuel supply device 13 for introducing liquid fuel 15 into the exhaust gas 7 guided through the exhaust gas recirculation system 8 is arranged in the exhaust gas recirculation system 8. The fuel supply device 13 is only shown highly schematically in FIG. 1. The fuel supply device 13 can comprise one or more fuel injectors 14 with the aid of which fuel 15 is injected in liquid form into the exhaust gas recirculation system 8. The fuel injectors 14 can also be configured as fuel nozzles so that the fuel 15 is injected into the exhaust gas recirculation system 8. The fuel 15 introduced into the exhaust gas recirculation system 8 is mixed with the exhaust gas 7 guided through the exhaust gas recirculation system 8. In other words, a mixture of exhaust gas 7 and fuel 15 is formed.

In addition, a fuel vaporizer 12 is arranged in the exhaust gas recirculation system 8 and specifically downstream of the fuel supply device 13, i.e. between the fuel supply device 13 and the fresh air supply 4. The term “downstream” here relates to a principal direction of flow of the exhaust gas 7 through the exhaust gas recirculation system 8. Accordingly, the fuel supply device 13 is arranged in relation to said principal direction of flow upstream of the fuel vaporizer 12, i.e. between the exhaust gas removal system 5 and the fuel vaporizer 12. The fuel vaporizer 12 is used for vaporizing the liquid fuel 15 mixed with the exhaust gas 7. In this case, hydrocarbons contained in the fuel 15 are converted chemically.

FIG. 2 shows the fuel vaporizer 12 in a separate view. According to FIG. 2, the fuel vaporizer 12 can have a vaporizer housing 16 by means of which the fuel vaporizer 12 is incorporated into the recirculation tube 11 or the recirculation line 10 of the exhaust gas recirculation system 8. The vaporizer housing 16 delimits a housing interior 17 through which the exhaust gas 7 and the fuel 15 can flow. A catalytic coating is provided on a housing inner wall 25, in particular on an inner circumferential wall of the vaporizer housing 16. The fuel vaporizer 12 is therefore configured as a catalytic fuel vaporizer 12 for conversion of long-chain hydrocarbons contained in the fuel 15 into shorter-chain hydrocarbons. To this end, oxidation reactions take place in the housing interior 17 incorporating the catalytic coating 18, by means of which by supplying oxygen (O₂) as oxidizing agent the long-chain hydrocarbon compound C₈H₁₈ is converted into the short-chain hydrocarbon compound C₃H₈. In so doing, carbon dioxide (CO₂) is released. The oxidation of the fuel 15 preferably takes place with severe air deficiency (2\, <0.1).

In order to reach the temperatures required to trigger the oxidation reactions in the exhaust gas 7, which are typically 300° C. and more, the fuel vaporizer 12 is provided with an electrical heating device 19. The electrical heating device 19 is used for heating the mixture of the exhaust gas 7 and the fuel 15 to be converted in the fuel vaporizer 12 if the exhaust gas 7 to be recirculated has not reached the required temperature level. If the temperature of the exhaust gas 7 is sufficiently high to trigger the oxidation reactions on entry to the fuel vaporizer 12, an additional heating of the mixture of fuel 15 and exhaust gas 7 by means of the electrical heating device 19 can be dispensed with. The electrical heating device 19 can for example be configured as an electrical heating coil 20 indicated only highly schematically in FIG. 2, which is arranged in the housing interior 17. The temperatures required for initiation of the oxidation reactions can be reached both with the aid of the electrical heating device 19 and also by means of the thermal energy contained in the hot exhaust gas 7 without the calorific value of the fuel 15 being reduced.

The gaseous fuel 15 with the short-chain hydrocarbon compounds C₃H₈ emerging from the fuel vaporizer 12 after conversion has a higher knocking resistance than the liquid fuel 15 with the long-chain hydrocarbon compound C₈H₁₈ before entry into the fuel vaporizer 12. In the example scenario the octane or knock number of the fuel 15 is increased in the course of conversion from ROZ 98 to a value of ROZ>=100.

In order to cool again the mixture of exhaust gas 7 and fuel 15 after conversion of the hydrocarbon compounds, an exhaust gas cooler 21 is arranged downstream of the fuel vaporizer 12, i.e. between the fuel vaporizer 12 and the fresh air supply 4. This is used for cooling the mixture of exhaust gas 7 and fuel 5 emerging from the fuel vaporizer. The exhaust gas cooler 21 is only indicated roughly schematically in the diagram in FIG. 1. The exhaust gas cooler 21 can be configured as a heat exchanger 22 or comprise such a heat exchanger 22. A technical implementation of such a heat exchanger 22 as a conventional stacked plate heat exchanger, in particular as a so-called ribbed tube heat exchanger is feasible. Other technical forms of realization are known to the relevant person skilled in the art and can therefore be implemented in the internal combustion engine 1 according to the invention.

The mixture to be cooled of exhaust gas 7 and converted fuel 15 with increased knock number flows through the heat exchanger 22 in a known manner. In addition—fluidically separated from this mixture of fuel 15 and exhaust gas 7—a coolant not shown in detail in FIG. 1 also flows through the heat exchanger 22. This coolant is thermally coupled to this mixture inside the heat exchanger 22 for cooling the mixture of fuel 15 and exhaust gas 7. The temperature of the mixture is reduced as desired by transfer of heat from the hot mixture of fuel 15 and exhaust gas 7 to the coolant.

After flowing through the exhaust gas cooler 21 or heat exchanger 22, the mixture of fuel 15 and exhaust gas 7 is introduced via a branch 23, which opens into the fresh air supply 4, from the exhaust gas recirculation system 8 into the fresh air supply 4. Thus, the exhaust gas 7 can be introduced again together with the fresh air 6 into the combustion chambers 3 of the internal combustion engine 1.

The previously described internal combustion engine 1 can be used in a motor vehicle which is fitted with a refrigeration system 28. Such a refrigeration system 28 can be part of an air-conditioning system installed in the motor vehicle by means of which the vehicle interior of the motor vehicle is air-conditioned. In this case, the refrigeration system 28 comprises a refrigeration circuit 29 in which the exhaust gas cooler 21 configured as a heat exchanger 22 is incorporated. In this case, the refrigerant K takes over the previously described function of a coolant for cooling the mixture of exhaust gas 7 and fuel 15. In this variant, the refrigeration system 28 present in the motor vehicle is therefore used for cooling the mixture of exhaust gas 7 and fuel 15. For this purpose the heat exchanger 22 can have first fluid paths which communicate fluidically with the refrigeration circuit 29 for the coolant K to flow through. Furthermore the heat exchanger 22 has second fluid paths which communicate fluidically with the exhaust gas recirculation system 8 for the mixture to be cooled of exhaust gas 7 and fuel 15 to flow through. In this case, the first fluid paths for cooling the mixture of exhaust gas 7 and fuel 15 are connected thermally to the second fluid paths in the heat exchanger 22.

1. An internal combustion engine for a motor vehicle, comprising:
at least one cylinder including a combustion chamber for combustion of an air-fuel mixture introduced into the combustion chamber;
a fresh air feed for supplying fresh air into the combustion chamber of the at least one cylinder;
an exhaust gas removal system for removing exhaust gas from the combustion chamber of the at least one cylinder;
an exhaust gas recirculation system fluidically communicating with the fresh air feed and the exhaust gas removal system for at least partial recirculation of the exhaust gas removed from the at least one cylinder into the at least one cylinder;
a fuel supply device arranged in the exhaust gas recirculation system for introducing a fuel into the exhaust gas guided through the exhaust gas recirculation system; and
a fuel vaporizer arranged in the exhaust gas recirculation system configured to chemically convert hydrocarbons contained in the fuel introduced into the exhaust gas.

2. The internal combustion engine according to claim 1, further comprising an exhaust gas cooler arranged downstream of the fuel vaporizer for cooling a mixture of the exhaust gas and the fuel emerging from the fuel vaporizer.

3. The internal combustion engine according to claim 1, wherein the fuel vaporizer is a catalytic fuel vaporizer configured to convert long-chain hydrocarbons contained in the fuel introduced into the exhaust gas into short-chain hydrocarbons.

4. The internal combustion engine according to claim 1, wherein the fuel vaporizer is configured to convert a hydrocarbon compound C₈H₁₈ into a hydrocarbon compound C₃H₈.

5. The internal combustion engine according to claim 1, wherein the fuel vaporizer is configured such that a chemical conversion of hydrocarbons contained in the fuel introduced into the exhaust gas increases a knock number of the fuel by at least 2 ROZ.

6. The internal combustion engine according to claim 1, wherein the fuel vaporizer includes a vaporizer housing defining a housing interior through which the exhaust gas and the fuel are flowable, and wherein a housing inner wall of the vaporizer housing includes a catalytic coating.

7. The internal combustion engine according to claim 1, wherein the fuel vaporizer includes an electrical heating device for heating a mixture of the exhaust gas and the fuel to be converted.

8. The internal combustion engine according to claim 1, wherein the fuel supply device includes at least one fuel injector for injecting the fuel into the exhaust gas recirculation system.

9. The internal combustion engine according to claim 2, wherein the exhaust gas cooler is a heat exchanger through which the mixture of the exhaust gas and the fuel to be cooled and a coolant fluidically separated from the mixture are flowable, and wherein the coolant is thermally coupled to the mixture of the exhaust gas and the fuel within the heat exchanger.

10. The internal combustion engine according to claim 1, wherein the internal combustion engine is a petrol engine.

11. A motor vehicle, comprising:
an internal combustion engine including:
at least one cylinder including a combustion chamber for combustion of an air-fuel mixture introduced into the combustion chamber;
a fresh air feed for supplying fresh air into the combustion chamber of the at least one cylinder;
an exhaust gas removal system for removing exhaust gas from the combustion chamber of the at least one cylinder;
an exhaust gas recirculation system fluidically communicating with the fresh air feed and the exhaust gas removal system for at least partial recirculation of the exhaust gas removed from the at least one cylinder into the at least one cylinder;
a fuel supply device arranged in the exhaust gas recirculation system for introducing a fuel into the exhaust gas guided through the exhaust gas recirculation system; and
a fuel vaporizer arranged in the exhaust gas recirculation system configured to chemically convert hydrocarbons contained in the fuel introduced into the exhaust gas.

12. The motor vehicle according to claim 11, further comprising a refrigeration system including a refrigeration circuit through which a coolant is flowable, wherein the refridgeration circuit includes an exhaust gas cooler configured as a heat exchanger.

13. The motor vehicle according to claim 12, wherein:
the heat exchanger includes a plurality of first fluid paths fluidically communicating with the refrigeration circuit for the coolant to flow through;
the heat exchanger further includes a plurality of second fluid paths fluidically communicating with the exhaust gas recirculation system for a mixture of the exhaust gas and the fuel to be cooled to flow through; and
the plurality of first fluid paths are connected thermally to the plurality of second fluid paths for cooling the mixture of the exhaust gas and the fuel in the heat exchanger.

14. The motor vehicle according to claim 12, further comprising an air-conditioning system including the refrigeration system for air conditioning a vehicle interior.

15. The motor vehicle according to claim 11, wherein the fuel vaporizer is a catalytic fuel vaporizer configured to convert long-chain hydrocarbons contained in the fuel introduced into the exhaust gas into short-chain hydrocarbons.

16. The motor vehicle according to claim 11, wherein the fuel vaporizer is configured to convert a hydrocarbon compound C₈H₁₈ into a hydrocarbon compound C₃H₈.

17. The motor vehicle according to claim 11, wherein the fuel vaporizer is configured such that a chemical conversion of hydrocarbons contained in the fuel introduced into the exhaust gas increases a knock number of the fuel by at least 2 ROZ.

18. The motor vehicle according to claim 11, wherein the fuel vaporizer includes a vaporizer housing defining a housing interior through which the exhaust gas and the fuel are flowable, and wherein a housing inner wall of the vaporizer housing includes a catalytic coating.

19. An internal combustion petrol engine for a motor vehicle, comprising:
at least one cylinder including a combustion chamber for combustion of an air-fuel mixture introduced into the combustion chamber;
a fresh air feed for supplying fresh air into the combustion chamber of the at least one cylinder;
an exhaust gas removal system for removing exhaust gas from the combustion chamber of the at least one cylinder;
an exhaust gas recirculation system fluidically communicating with the fresh air feed and the exhaust gas removal system for at least partial recirculation of the exhaust gas removed from the at least one cylinder into the at least one cylinder;
a fuel supply device arranged in the exhaust gas recirculation system for introducing a fuel into the exhaust gas guided through the exhaust gas recirculation system;
a catalytic fuel vaporizer arranged in the exhaust gas recirculation system configured to chemically convert long-chain hydrocarbons contained in the fuel introduced into the exhaust gas into short-chain hydrocarbons; and
an exhaust gas cooler arranged downstream of the fuel vaporizer for cooling a mixture of the exhaust gas and the fuel emerging from the fuel vaporizer.

20. The internal combustion petrol engine according to claim 19, wherein the fuel vaporizer is configured such that a chemical conversion of hydrocarbons contained in the fuel introduced into the exhaust gas increases a knock number of the fuel by at least 2 ROZ.
